(19) United States
(12) Patent Application Publication
(10) Pub. No.: US 2026/0062228 A1
(43) Pub. Date: Mar. 5, 2026

(54) BELT CLEANING DEVICE FOR COAL LOADING AND UNLOADING BELT CONVEYOR

(71) Applicant: Qinhuangdao Port Co., Ltd., Qinhuangdao (CN)

(72) Inventors: Jinggang SUN, Qinghuangdao (CN); Yancheng LI, Qinghuangdao (CN); Chao WU, Qinghuangdao (CN); Xianshuang MENG, Qinghuangdao (CN); Lei WANG, Qinghuangdao (CN); Xiaochuan YANG, Qinghuangdao (CN); Zhongli WEI, Qinghuangdao (CN); Jian WANG, Qinghuangdao (CN); Peng WANG, Qinghuangdao (CN); Xu YANG, Qinghuangdao (CN); Liang SHANG, Qinghuangdao (CN); Mengnan LI, Qinghuangdao (CN); Linlin CAI, Qinghuangdao (CN); Zijian WANG, Qinghuangdao (CN); Ailin YANG, Qinghuangdao (CN); Cheng ZHANG, Qinghuangdao (CN); Meng SUN, Qinghuangdao (CN); Desheng LI, Qinghuangdao (CN)

(21) Appl. No.: 19/180,158

(22) Filed: Apr. 16, 2025

(30) Foreign Application Priority Data
Sep. 3, 2024 (CN) 202411229890.3

(51) Int. Cl. B65G 45/16; B65G 45/14; B65G 45/22

(52) U.S. Cl. CPC B65G 45/16; B65G 45/14; B65G 45/22

(57) ABSTRACT

A belt cleaning device for a coal loading and unloading belt conveyor, including a split-type spraying pipe, a first alloy scraper, and a second alloy scraper. The first alloy scraper is provided on the belt, the belt is supported by a roller. The second alloy scraper is elastically pushed against an underside of the belt and suspended below the roller. A material scraping area is covered by the split-type spraying pipe, the split-type spraying pipe is configured to spray water onto the material scraping area. The belt cleaning device can independently control the inclination angle of the first alloy scraper and the second alloy scraper and uniformly control the adhesion force between the alloy scrapers and the belt, thus solving the problem of scraping off adhesive materials at different wear rates of the belt, improving the efficiency of the coal loading and unloading belt conveyor, and reducing maintenance needs.

### CROSS REFERENCE TO RELATED APPLICATIONS

This application claims foreign priority of Chinese Patent Application No. 202411229890.3, filed on Sep. 3, 2024 in the China National Intellectual Property Administration, the disclosures of all of which are hereby incorporated by reference.

### TECHNICAL FIELD

The present disclosure relates to the technical field of port transportation equipment technology, in particular to a belt cleaning device for coal loading and unloading belt conveyor.

### BACKGROUND

In modern industrial production, belt conveyors are commonly used for transporting bulk materials, including coal. Due to their widespread application in various heavy industrial settings, the efficiency and maintenance of belt conveyors are key factors in enhancing overall production efficiency. Although belt conveyors are efficient and convenient in the material transportation process, the materials inevitably leave residues on the conveyor belt, which not only reduces the lifespan of the belt but also causes environmental pollution. Therefore, effective cleaning solutions are required to maintain the cleanliness of the equipment and extend its service life.

Currently, the cleaning methods of belt conveyors mostly relies on cleaning devices installed at the head of the conveyor, such as traditional polyurethane scrapers or rubber scrapers. While these scrapers can effectively remove some material residues initially, their wear accelerates with usage, resulting in a significant decline in cleaning efficiency and sustainability. Especially when handling highly viscous or wet materials, these traditional scraper materials often struggle to thoroughly clean the conveyor belt, leading to low efficiency, serious material return on the return belt, and increased maintenance and operational costs.

In addition to the polyurethane or rubber scrapers mentioned above, existing technologies also add multiple scraper devices at the discharge end of the conveyor to scrape off the viscous materials adhered to the belt by controlling the contact between the scrapers and the belt's pre-tension. However, the problem is how to control the pre-tension of the scraper heads to the belt. When the pre-tension force is too large, the material removal effect is better, it creates substantial resistance to the overall transportation of the belt and leads to higher energy consumption. Additionally, this also causes significant wear on both the scraper head and the belt. Furthermore, regardless of whether the scraper head is integral or split, current technology controls the pre-tension force by adding shims to the scraper head and using feeler gauges at the contact point between the scraper head and the belt to measure whether the feeler gauge can fit into the gap. However, the wear rate of the belt along its width is often uneven. In the same Y-direction range, under the condition of the scraper head rotating at the same tilt angle and pressing against the outer wall of the belt, sometimes the feeler gauge can be inserted, and sometimes it cannot, making it difficult to control and verify the pre-tension force between the scraper head and the belt.

Given the limitations of current technology, there is an urgent need in the industry for a coal unloading belt conveyor cleaning device that can independently control the tilt angle of each scraper head and uniformly control the contact force between the scraper head and the belt. This solution would address the problem of removing adhered materials from areas with different wear rates on the same belt, improve the efficiency of the belt conveyor, reduce maintenance needs, adapt to various industrial environments and different material characteristics, and decrease reliance on additional space and auxiliary equipment.

### SUMMARY

The present disclosure provides a belt cleaning device for a coal loading and unloading belt conveyor, to solve the shortcomings of the prior art. The belt cleaning device can effectively clean belt of the coal loading and unloading belt conveyor, and is highly integrated to achieve efficient cleaning operations even in situations where installation space is limited.

To realize the above objective, the present disclosure provides a belt cleaning device for a coal loading and unloading belt conveyor, the belt cleaning device for the coal loading and unloading belt conveyor is arranged on an inner wall of a shell of a discharge end of an coal loading and unloading belt conveyor, a material delivery direction of the belt is defined as an X direction, a width direction of the belt is defined as a Y direction, and a gravity direction is defined as a Z direction; the belt cleaning device comprises a split-type spraying pipe, a first alloy scraper, and a second alloy scraper; and

the first alloy scraper is provided on the belt, the belt is supported by a roller of the coal loading and unloading belt conveyor; and the second alloy scraper is elastically pushed against an underside of the belt, and the second alloy scraper is suspended below the roller; and a material scraping area along the Y direction is covered by the split-type spraying pipe, the split-type spraying pipe is configured to spray water onto the material scraping area where the first alloy scraper and the second allay scraper meet the belt.

Furthermore, the first alloy scraper comprises a first fixed frame, a first movable frame, a Y-direction branch pipe, a multiple sets of clutch transmitting units, a scraper holder, a scraper seat, and a first scraper; the first fixed frame is fixed on an inner wall of the shell of the discharge end of the coal loading and unloading belt conveyor; the first fixed frame is set to slide along the X direction, and elastically abutted to the first movable frame; and the first movable frame is fixedly connected to the Y-direction branch pipe along the Y direction; and a multiple of Y-direction spaced access holes are provided on a wall of the Y-direction branch pipe; and the multiple sets of the clutch transmitting units are arranged in the Y-direction branch pipe, the multiple sets of the clutch transmitting units are configured to provide clutch power for adjusting a tilt angle of the scraper holder and an elastic pre-tension fitting with the belt; and the scraper holder is set to slide through the access holes, and the scraper seat is fixed on a top of the scraper holder to support the first scraper.

Furthermore, the second alloy scraper comprises a second fixed frame, a second movable frame, a lifting rod, a second leaf spring, and a second scraper; the second fixed frame is fixed on the inner wall of the shell near the discharge end of the coal loading and unloading belt conveyor; and a Z-direction guiding rod is penetrated and slid through the second fixed frame in a the Z-direction; a lower part of the Z-direction guiding rod is fixedly connected to a top surface of the second movable frame; and an upper part of the Z-direction guiding rod is equipped with a Z-direction pre-tension spring, the Z-direction pre-tension spring is configured to provide upward support for the Z-direction guiding rod and the second movable frame; a lifting rod is fixedly connected to the second movable frame along the Y direction, and a second leaf spring is fixed on the lifting rod; another end of the second leaf spring is fixed with the second scraper, and the second scraper is fitted against a surface of the belt.

Furthermore, the upper part of the first fixed frame is fixed with a Y-direction guiding rod; the Y-direction guiding rod is slid through and connected to the first movable frame; and one end of the Y-direction guiding rod is fitted with a nut to adjust the pre-tension force, and the Y-direction guiding rod is elastically connected to a Y-direction pre-tension spring of the first movable frame.

Furthermore, each set of the clutch transmitting units comprises a rotating rod, which is coaxial and rotates inside the Y-direction branch pipe; a multiple sets of turntables, ratchets, pawls, and pawl springs are arranged at intervals along the Y direction of the rotating rod; each of the pawls is configured to elastically support an outer circumferential wall of a ratchet in a same set; the turntables are axially limited and mounted on the rotating rod, and the turntables are configured to rotate along with the rotating rod, with a outer circumference of each of the turntables is radially fixed to the scraper holder through the access holes; and when taking each of the ratchets as a reference, an axial end face of each of the turntables is extended tangentially and telescopically supported each of the pawls, while each of the pawl springs is hinged on an axial end face of each of the turntables to provide elastic support force for each of the pawls; and each of the ratchets is coaxially fixed on the rotating rod, and each of the ratchets is configured to drive each of the turntables to rotate in a clutch mechanism.

Furthermore, the first fixed frame is provided with a guiding plate, the guiding plate is V-shaped and inclined; an inlet end of the guiding plate is positioned at a high position and extends downward below the second alloy scraper, and an outlet end of the guiding plate is positioned at a low position and extends obliquely downward toward the roller of the coal loading and unloading belt conveyor.

Furthermore, the scraper holder comprises a fixed plate, a first leaf spring, and a zigzag supporting frame, which are sequentially fixed, with the fixed plate passing through the access holes of the Y-direction branch pipe and fixedly connected to a turntable in a same set; a top side of the zigzag supporting frame is fixed with the scraper seat, and another side of the zigzag supporting frame is hung with a waterproof curtain in the Z-direction.

Furthermore, a cross-section of the scraper seat is a T-shaped structure, a vertical side wall of a lower part of the scraper seat is bolted to the scraper holder, and a upper plane of the scraper seat is fixed with first scrapers, the first scrapers are made of tungsten carbide.

Furthermore, each of the split-type spraying pipes comprises two segments, and the two segments are fixed on both sides of the shell at the discharge end of the coal loading and unloading belt conveyor, with a plurality of nozzles fixed along the Y direction on each of the split-type spraying pipes, the nozzles are configured to spray water onto the material scraping area where the first alloy scraper and the second alloy scraper meet the belt.

The belt cleaning device for the coal loading and unloading belt conveyor of the present disclosure sprays high-pressure water onto the alloy scrapers and the belt's scraping contact area through a split-type spraying pipe. On one hand, it sprays water to clean the sticky materials accumulated on the scraper holder, the first alloy scraper, and waterproof curtain. On the other hand, it replenishes the moisture content of the sticky materials accumulated at the contact area between the alloy scrapers and the belt, increasing the water saturation level of the sticky materials to reduce their viscosity, which helps in their detachment.

The belt cleaning device for the coal loading and unloading belt conveyor of the present disclosure provides an elastic support for the belt through the alloy scraper, independently adjusting the angle of the scraper holder according to the wear rate at different parts of the same belt. It ensures the uniformity of the contact force between multiple scraper holders and the belt.

Specifically, the first fixed frame is elastically connected to the first movable frame along the X-direction, providing X-direction coarse adjustment pre-tightening force control for the first movable frame and multiple sets of clutch transmitting units, scraper holder, scraper seat, and first scraper.

The multiple sets of clutch transmitting units in the Y-direction branch pipes provide rotational power with a clutch function to the scraper holder. When the first scraper on a specific scraper holder contacts the belt and applies sufficient pre-tightening force, the claw of the clutch transmitting unit disengages from the current ratchet position and jumps to the next engagement position. Leading the turntable and the ratchet disengage from the synchronized rotation relationship and rotate relatively. This ensures that the clutch transmitting units apply the same rotational force to the scraper holders, and the tilt angle of a specific scraper holder can be independently adjusted to adapt to the wear rate of different parts of the same belt. This allows for secondary fine adjustment of the pre-tightening force control between the first scraper and the belt.

### BRIEF DESCRIPTION OF THE DRAWINGS

FIG. 1 is a schematic structural diagram of a belt cleaning device for a coal loading and unloading belt conveyor according to an embodiment of the present disclosure.

FIG. 2 is a schematic structural diagram of the belt cleaning device for a coal loading and unloading belt conveyor with a part of a waterproof curtain hidden.

FIG. 3 is a front view of the belt cleaning device for the coal loading and unloading belt conveyor in FIG. 1.

FIG. 4 is a right side view of the belt cleaning device for the coal loading and unloading belt conveyor in FIG. 1.

FIG. 5 is an enlarged view of point A in FIG. 2.

FIG. 6 is a cross-sectional structure view of a multiple sets of clutch transmitting units inside a Y-direction branch pipe according to an embodiment of the present disclosure;

FIG. 7 is a schematic diagram of the ratchet and pawl connection structure of the clutch transmitting unit according to an embodiment of the present disclosure;

FIG. 8 is a schematic diagram of the side structure of the scraper holder, scraper seat, and first scraper according to an embodiment of the present disclosure.

### DESCRIPTION OF THE REFERENCE NUMERAL

1 split-type spraying pipe, 2 nozzle, 3 belt, 4 roller, 5 second alloy scraper, 6 first alloy scraper, 7 waterproof curtain, 8 guiding plate, 9 Y-direction pre-tension spring, 10 Y-direction guiding rod, 11 first scraper, 12 scraper holder, 13 first leaf spring, 14 fixed plate, 15 first movable frame, 16 access hole, 17 Y-direction branch pipe, 18 rotating rod, 19 turntable, 20 ratchet, 21 pawl, 22 pawl spring, 23 pawl support, 24 scraper seat, 25 second scraper, 26 second leaf spring, 27 Z-direction guiding rod, 28 Z-direction pre-tension spring, 30 second movable frame, 31 lifting rod.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

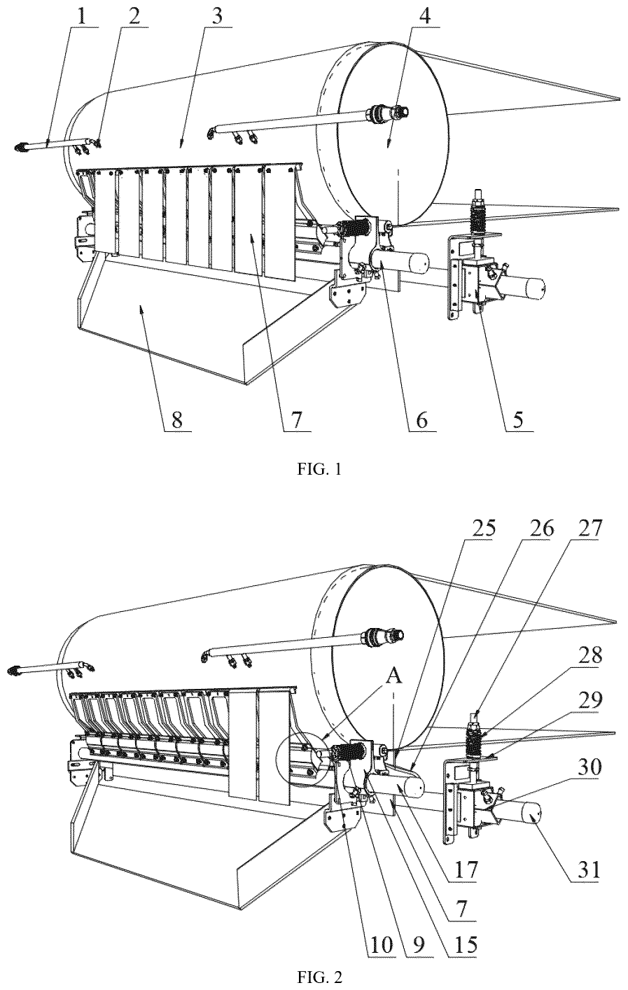

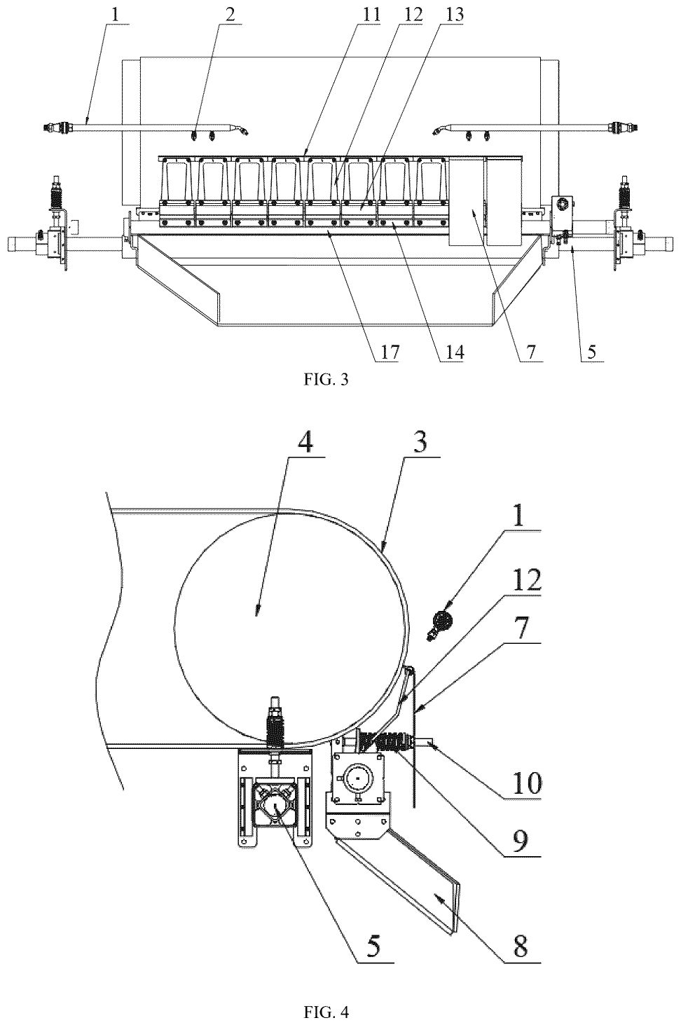

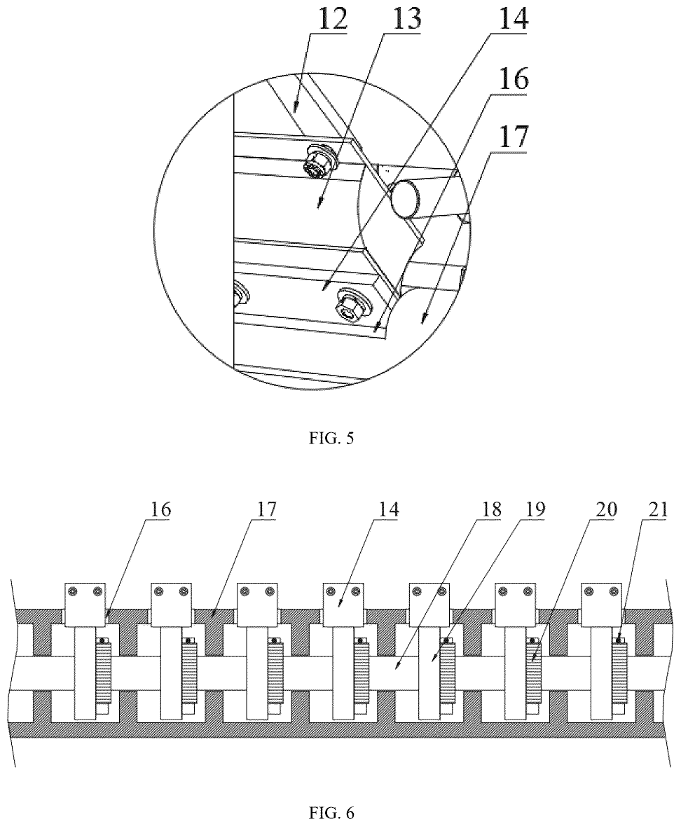

Please refers to FIGS. 1-6, the present disclosure provides a belt cleaning device for a coal loading and unloading belt conveyor, the belt cleaning device for the coal loading and unloading belt conveyor is arranged on an inner wall of a shell of a discharge end of an coal loading and unloading belt conveyor. A material delivery direction of the belt 3 is defined as an X direction, a width direction of the belt 3 is defined as a Y direction, and a gravity direction is defined as a Z direction. The belt cleaning device includes a split-type spraying pipe 1, a first alloy scraper 6, and a second alloy scraper 5. The first alloy scraper 6 is provided on the belt 3, the belt 3 is supported by a roller of the coal loading and unloading belt conveyor. The split-type spraying pipe 1 is directly connected to a high-pressure water source, relying on the pressure of high-pressure water to flush the adhesive materials on the belt 3, thereby preventing material accumulation.

The second alloy scraper 5 is elastically pushed against an underside of the belt 3, and the second alloy scraper 5 is suspended below the roller 4. A material scraping area along the Y direction is covered by the split-type spraying pipe 1, the split-type spraying pipe 1 is configured to spray water onto the material scraping area where the first alloy scraper 6 and the second allay scraper 5 meet the belt 3.

The first alloy scraper comprises a first fixed frame, a first movable frame 15, a Y-direction branch pipe 17, a multiple sets of clutch transmitting units, a scraper holder 12, a scraper seat 24, and a first scraper 11. The first fixed frame is fixed on an inner wall of the shell of the discharge end of the coal loading and unloading belt conveyor. The first fixed frame is set to slide along the X direction, and elastically abutted to the first movable frame 15. The first movable frame 15 is fixedly connected to the Y-direction branch pipe along the Y direction. A multiple of Y-direction spaced access holes 16 are provided on a wall of the Y-direction branch pipe 17. The multiple sets of the clutch transmitting units are arranged in the Y-direction branch pipe 17, the multiple sets of the clutch transmitting units are configured to provide clutch power for adjusting a tilt angle of the scraper holder 12 and an elastic pre-tension fitting with the belt 3. And the scraper holder 12 is set to slide through the access holes 16, and the scraper seat 24 is fixed on a top of the scraper holder 12 to support the first scraper 11.

The second alloy scraper includes a second fixed frame 29, a second movable frame 30, a lifting rod 31, a second leaf spring 26, and a second scraper 25. The second fixed frame 29 is fixed on the inner wall of the shell near the discharge end of the coal loading and unloading belt conveyor. A Z-direction guiding rod 27 is penetrated and slid through the second fixed frame 29 in a the Z-direction. A lower part of the Z-direction guiding rod 27 is fixedly connected to a top surface of the second movable frame 30. An upper part of the Z-direction guiding rod 27 is equipped with a Z-direction pre-tension spring 28, the Z-direction pre-tension spring 28 is configured to provide upward support for the Z-direction guiding rod 27 and the second movable frame 30. A lifting rod 31 is fixedly connected to the second movable frame 30 along the Y direction. A second leaf spring 26 is fixed on the lifting rod 31. Another end of the second leaf spring 26 is fixed with the second scraper 25, and the second scraper 25 is fitted against a surface of the belt 3.

The upper part of the first fixed frame is fixed with a Y-direction guiding rod 10. The Y-direction guiding rod 10 is slid through and connected to the first movable frame 15. One end of the Y-direction guiding rod 10 is fitted with a nut to adjust the pre-tension force, and the Y-direction guiding rod 10 is elastically connected to a Y-direction pre-tension spring 9 of the first movable frame 15.

Each set of the clutch transmitting units includes a rotating rod 18, which is coaxial and rotates inside the Y-direction branch pipe 17. A multiple sets of turntables 19, ratchets 20, pawls 21, and pawl springs 22 are arranged at intervals along the Y direction of the rotating rod 18. Each of the pawls 21 is configured to elastically support an outer circumferential wall of a ratchet 20 in a same set. The turntables 19 are axially limited and mounted on the rotating rod 18, and the turntables are configured to rotate along with the rotating rod 18, with a outer circumference of each of the turntables 19 is radially fixed to the scraper holder 12 through the access holes 16. When taking each of the ratchets 20 as a reference, an axial end face of each of the turntables 19 is extended tangentially and telescopically supported each of the pawls 21, while each of the pawl springs 22 is hinged on an axial end face of each of the turntables 19 to provide elastic support force for each of the pawls 21; and each of the ratchets 20 is coaxially fixed on the rotating rod 18, and each of the ratchets 20 is configured to drive each of the turntables 19 to rotate in a clutch mechanism.

The first fixed frame is provided with a guiding plate 8, the guiding plate is V-shaped and inclined. An inlet end of the guiding plate 8 is positioned at a high position and extends downward below the second alloy scraper 5, and an outlet end of the guiding plate 8 is positioned at a low position and extends obliquely downward toward the roller 4 of the coal loading and unloading belt conveyor.

The scraper holder 12 includes a fixed plate 14, a first leaf spring 13, and a zigzag supporting frame, which are sequentially fixed, with the fixed plate 14 passing through the access holes 16 of the Y-direction branch pipe 17 and fixedly connected to a turntable 19 in a same set. The first leaf spring 13 is U-shaped. A top side of the zigzag supporting frame 27 is fixed with the scraper seat 24, and another side of the zigzag supporting frame 27 is hung with a waterproof curtain in the Z-direction.

A cross-section of the scraper seat 24 is a T-shaped structure, a vertical side wall of a lower part of the scraper seat 24 is bolted to the scraper holder 12, and a upper plane of the scraper seat 24 is fixed with first scrapers 11, the first scrapers 11 are made of tungsten carbide.

Each of the split-type spraying pipes 1 includes two segments, and the two segments are fixed on both sides of the shell at the discharge end of the coal loading and unloading belt conveyor, with a plurality of nozzles 2 fixed along the Y direction on each of the split-type spraying pipes 1, the nozzles 2 are configured to spray water onto the material scraping area where the first alloy scraper 6 and the second alloy scraper 5 meet the belt.

Due to the presence of impurities such as straw, rubber threads, etc., in the coal transported on the belt, these impurities are easily caught on the spraying pipes during transport. Additionally, since the coal being conveyed has a certain moisture content, it is prone to freezing into clumps on the belt during winter. Therefore, to facilitate the discharge of impurities and large chunks of material, the present disclosure divides each split-type spraying pipe 1 into two segments. The spacing between the two segments of each split spraying pipe 1 is 800 mm, which provides space for the material to fall.

The nozzles 2 emit water in a fan-shaped distribution that can cover the entire width of the belt. The nozzles 2 at the ends of the split-type spraying pipes 1 are set at a certain angle of inclination. The fan-shaped water streams from these two inclined nozzles 2 overlap in the middle of the belt 3. Since the material tends to concentrate in the middle of the belt 3 during transport, the overlapping water streams can strengthen the flushing of the material adhering to the center of the belt 3, thereby improving the flushing effect.

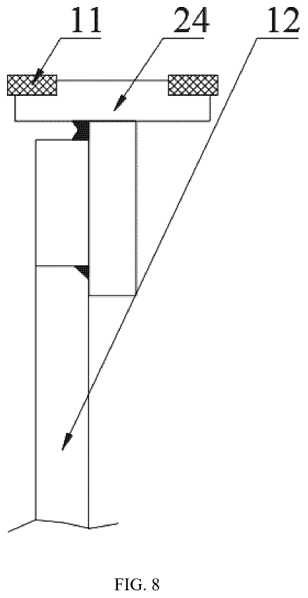

In addition, according to the present disclosure, both the first scraper 11 and the second scraper 25 are made of tungsten carbide material. As shown in FIG. 8, the first scraper 11 is arranged on both sides of the top surface of the scraper holder 12. One side of the scraper is used to press the belt, while the other side is either kept as a spare or prevents damage to the scraper holder 12 when coal blocks fall. When one side of the scraper wears out, the connection between the scraper holder 12 and the scraper seat 24 is reversed, allowing the other side of the scraper to continue pressing the belt 3.

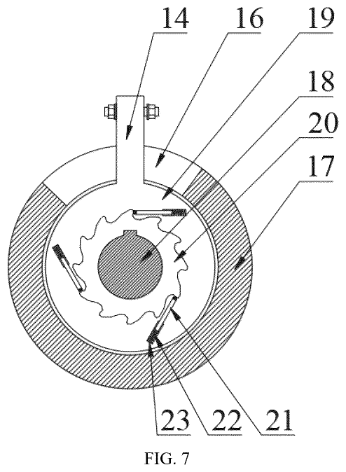

Furthermore, as shown in FIG. 7, a number of pawl supports 23 are tangentially fixed on the turntables 19. One end of each of the pawl supports 13 slides to insert a pawl 21, and the interior of each pawl support 13 is elastically topped to connect with a pawl spring 22 that provides the force for extending the pawls 21. Additionally, the tip of each pawl 1 is bonded with a cushioning pad made of a flexible material.

The working principle of the belt cleaning device for the coal loading and unloading belt conveyor of the present disclosure is as follows: the first alloy scraper 6 is used to initially scrape off the sticky powdery coal material from the belt 3. During the scraping process, one split-type spraying pipe 1 covers and rinses the sticky coal material in the Y-direction (belt width direction), to replenish the saturated moisture content of the sticky coal material, thereby reducing its viscosity, which facilitates the removal of the material after scraping by the waterproof curtain and guiding plate 8, and the material then falls onto the lower belt 3.

It should be noted that, before the first alloy scraper 6 scrapes off the sticky coal material on the belt 3, the pressing force of multiple first scrapers 11 on the first alloy scraper 6 should be tested. If a 0.04 mm feeler gauge cannot pass through the gap between the first scrapers 11 and the belt 3, the test is considered successful. When adjusting the pressing force of the first scrapers 11, rotational power must be provided to the rotating rod 18. The ratchets 20 on the rotating rod 18 drives the pawl's clutching mechanism, allowing the rotating rod 18, ratchets 20, and turntables 19 to perform synchronized rotational actions. This continues until the corresponding first scraper on all turntables presses onto the belt 3 (at this point, the scraper holders 12 on different turntables 19 are independently set to adaptively support and press the scrapers against the belt 3, with slight differences in the rotation angle of the scraper holders, approximately 3-5°. However, the pressing force applied by the scraper holders and scrapers to the belt is uniformly determined by the rotational force of the rotating rod 18 divided by the number of clutch transmitting units, ensuring the uniformity of the pressing force).

Finally, the second alloy scraper 5 supports the second scraper 25 in an elastic lifting buffer manner, so that the second scraper 25 presses against the lower surface of the belt 3 to scrape off the remaining moisture or coal dust particles on the belt 3.

Any aspects not detailed in this disclosure use mature products and technologies from existing techniques.

In the description of this specification, reference terms such as “an embodiment,” “some embodiments,” “example,” “specific example,” or “some examples” are intended to mean that the specific features, structures, materials, or characteristics described in the embodiment or example are included in the embodiments or examples of the present disclosure.

Although the embodiments of the present disclosure have been shown and described, those skilled in the art will understand that various modifications, variations, substitutions, and alterations can be made to these embodiments without departing from the principles and spirit of the disclosure. The scope of the present disclosure is defined by the claims and their equivalents.

1. A belt cleaning device for a coal loading and unloading belt conveyor, the belt cleaning device for the coal loading and unloading belt conveyor is arranged on an inner wall of a shell of a discharge end of an coal loading and unloading belt conveyor, a material delivery direction of the belt is defined as an X direction, a width direction of the belt is defined as a Y direction, and a gravity direction is defined as a Z direction;
wherein the belt cleaning device comprises a split-type spraying pipe, a first alloy scraper, and a second alloy scraper; and
the first alloy scraper is provided on the belt, the belt is supported by a roller of the coal loading and unloading belt conveyor; and
the second alloy scraper is elastically pushed against an underside of the belt, and the second alloy scraper is suspended below the roller; and
a material scraping area along the Y direction is covered by the split-type spraying pipe, the split-type spraying pipe is configured to spray water onto the material scraping area where the first alloy scraper and the second allay scraper meet the belt.

2. The belt cleaning device for the coal loading and unloading belt conveyor according to claim 1, wherein the first alloy scraper comprises a first fixed frame, a first movable frame, a Y-direction branch pipe, a multiple sets of clutch transmitting units, a scraper holder, a scraper seat, and a first scraper;
wherein the first fixed frame is fixed on an inner wall of the shell of the discharge end of the coal loading and unloading belt conveyor; the first fixed frame is set to slide along the X direction, and elastically abutted to the first movable frame; and
the first movable frame is fixedly connected to the Y-direction branch pipe along the Y direction; and
a multiple of Y-direction spaced access holes are provided on a wall of the Y-direction branch pipe; and
the multiple sets of the clutch transmitting units are arranged in the Y-direction branch pipe, the multiple sets of the clutch transmitting units are configured to provide clutch power for adjusting a tilt angle of the scraper holder and an elastic pre-tension fitting with the belt; and
the scraper holder is set to slide through the access holes, and the scraper seat is fixed on a top of the scraper holder to support the first scraper.

3. The belt cleaning device for the coal loading and unloading belt conveyor according to claim 1, wherein the second alloy scraper comprises a second fixed frame, a second movable frame, a lifting rod, a second leaf spring, and a second scraper;
wherein the second fixed frame is fixed on the inner wall of the shell near the discharge end of the coal loading and unloading belt conveyor; and
a Z-direction guiding rod is penetrated and slid through the second fixed frame in a the Z-direction;
wherein a lower part of the Z-direction guiding rod is fixedly connected to a top surface of the second movable frame; and
an upper part of the Z-direction guiding rod is equipped with a Z-direction pre-tension spring, the Z-direction pre-tension spring is configured to provide upward support for the Z-direction guiding rod and the second movable frame;
a lifting rod is fixedly connected to the second movable frame along the Y direction, and a second leaf spring is fixed on the lifting rod; another end of the second leaf spring is fixed with the second scraper, and the second scraper is fitted against a surface of the belt.

4. The belt cleaning device for a coal loading and unloading belt conveyor according to claim 2, wherein the upper part of the first fixed frame is fixed with a Y-direction guiding rod;
wherein the Y-direction guiding rod is slid through and connected to the first movable frame; and
one end of the Y-direction guiding rod is fitted with a nut to adjust the pre-tension force, and the Y-direction guiding rod is elastically connected to a Y-direction pre-tension spring of the first movable frame.

5. The belt cleaning device for the coal loading and unloading belt conveyor according to claim 2, wherein each set of the clutch transmitting units comprises a rotating rod, which is coaxial and rotates inside the Y-direction branch pipe; a multiple sets of turntables, ratchets, pawls, and pawl springs are arranged at intervals along the Y direction of the rotating rod;
wherein, each of the pawls is configured to elastically support an outer circumferential wall of a ratchet in a same set;
the turntables are axially limited and mounted on the rotating rod, and the turntables are configured to rotate along with the rotating rod, with a outer circumference of each of the turntables is radially fixed to the scraper holder through the access holes; and
when taking each of the ratchets as a reference, an axial end face of each of the turntables is extended tangentially and telescopically supported each of the pawls, while each of the pawl springs is hinged on an axial end face of each of the turntables to provide elastic support force for each of the pawls; and
each of the ratchets is coaxially fixed on the rotating rod, and each of the ratchets is configured to drive each of the turntables to rotate in a clutch mechanism.

6. The belt cleaning device for the coal loading and unloading belt conveyor according to claim 2, wherein the first fixed frame is provided with a guiding plate, the guiding plate is V-shaped and inclined;
an inlet end of the guiding plate is positioned at a high position and extends downward below the second alloy scraper, and an outlet end of the guiding plate is positioned at a low position and extends obliquely downward toward the roller of the coal loading and unloading belt conveyor.

7. The belt cleaning device for the coal loading and unloading belt conveyor according to claim 5, wherein the scraper holder comprises a fixed plate, a first leaf spring, and a zigzag supporting frame, which are sequentially fixed, with the fixed plate passing through the access holes of the Y-direction branch pipe and fixedly connected to a turntable in a same set;
a top side of the zigzag supporting frame is fixed with the scraper seat, and another side of the zigzag supporting frame is hung with a waterproof curtain in the Z-direction.

8. The belt cleaning device for the coal loading and unloading belt conveyor according to claim 2, wherein a cross-section of the scraper seat is a T-shaped structure, a vertical side wall of a lower part of the scraper seat is bolted to the scraper holder, and a upper plane of the scraper seat is fixed with first scrapers, the first scrapers are made of tungsten carbide.

9. The belt cleaning device for the coal loading and unloading belt conveyor according to claim 1, wherein each of the split-type spraying pipes comprises two segments, and the two segments are fixed on both sides of the shell at the discharge end of the coal loading and unloading belt conveyor, with a plurality of nozzles fixed along the Y direction on each of the split-type spraying pipes, the nozzles are configured to spray water onto the material scraping area where the first alloy scraper and the second alloy scraper meet the belt.
